(19) United States
(12) Patent Application Publication
(10) Pub. No.: US 2015/0298311 A1
(43) Pub. Date: Oct. 22, 2015

(54) MANUALLY GUIDED, PETROL-POWERED IMPLEMENT

(71) Applicant: HILTI AKTIENGESELLSCHAFT, Schaan (LI)

(72) Inventors: Ralf Meixner, Germaringen (DE); Guenther Veik, Maeder (AT); Dragomir Ljubojevic, St. Gallen (CH); Helmut Specht, Bad Woerishofen (DE)

(21) Appl. No.: 14/433,121

(22) PCT Filed: Oct. 2, 2013
(86) PCT No.: PCT/EP2013/070499

§ 371 Date: Apr. 2, 2015

(30) Foreign Application Priority Data
Oct. 3, 2012 (DE) 10 2012 218 070.2

(51) Int. Cl. B25F 5/02; B23D 47/00; B23D 45/16

(52) U.S. Cl. CPC B25F 5/02; B23D 45/16; B23D 47/00

(57) ABSTRACT

A handheld, gasoline-powered power tool (10) includes a tool (12) in the front section of the power tool (10), a first handle (14) in a center upper section of the power tool (10) and a second handle (20) in a rear section of the power tool (10). In addition, the power tool (10) includes s a footrest plate (28) located in the center lower section of the power tool (10), the footrest plate (28) offering a defined foot placement surface so that the user can clearly see where and how to hold the power tool (10) only with the foot.

The present invention relates to a handheld, gasoline-powered power tool such as a disc grinder with an internal combustion engine.

### BACKGROUND

When it comes to the handles and the handling, such power tools can be divided into the so-called rear-handle devices and the so-called top-handle devices. In the case of the rear-handle devices, aside from the front upper bar grip, which runs perpendicular to the longitudinal axis of the device, there is also a second handle (gas handle), which is arranged at the rear end of the device. With top-handle devices, in contrast, the second handle is situated on the top of the engine block. In comparison to the rear-handle devices, the top-handle devices—which are designed for special applications—have a more compact form and, if necessary, can be operated with one hand.

The internal combustion engine of such a power tool is started mechanically by means of a starter rope. During the starting procedure, the power tool has to be held firmly because of the reaction forces or reaction torques generated when the starter rope is pulled. From an ergonomic standpoint, starting the internal combustion engine of rear-handle devices is relatively easy in that the user places one foot into the rear handle while holding the front handle with one hand. For this purpose, however, a sufficiently large opening that can accommodate a shoe has to be provided in the area of the handle. This, however, runs counter to the notion of a compact design. Moreover, at least the lower part of the handle has to be configured so as to be commensurately sturdy, which makes the part more complex.

A power tool with the above-mentioned type of rear handle is shown in international patent application WO 2011/049498 A1. This document describes a special embodiment of a footrest surface located on the rear handle. Additional ribs or the like are intended to impart a better grip for the foot.

Even though top-handle devices can be held by the front handle when they are being started, the torque that occurs when the starter rope is pulled also lifts the rear section of the device, so that it is also necessary to hold onto this section. However, no special placement surface is provided on the top of the device for the knee or foot of the user, an aspect that is not ergonomic and that also entails the risk of slipping as well as damage to housing components. Moreover, if a foot is placed on top of the device, dirt might get into the area of the filling neck of the tank, especially from the shoe of the user. In this manner, dirt can get into the tank when the tank cap is opened later on. Since the construction of the handle here is typically compact, meaning that less space is available, it is not possible to place a foot in the area of the handle as is done with rear-handle devices.

### SUMMARY OF THE INVENTION

It is an object of the present invention to provide for the user of a handheld, gasoline-operated power tool, especially a top-handle device, to safely and ergonomically hold onto the power tool during the starting procedure.

The present invention provides that the handheld, gasoline-operated power tool comprises a tool in the front section of the power tool, a first handle in a center upper section and a second handle in a rear section of the power tool. The power tool according to the invention is characterized by a footrest plate located in the center lower section of the power tool.

The invention is based on the recognition of the fact that a footrest plate allows the user to simply and conveniently hold the power tool with the foot during the starting procedure. The footrest plate offers a defined foot placement surface so that the user can clearly see where and how to hold the power tool only with the foot. In this context, the positioning of the footrest plate in the center section is advantageous since no substantial tilting torques can occur during the starting procedure. In particular, it is not necessary to additionally hold the power tool by the first (front) handle or by the second (rear) handle.

Accordingly, in the case of a rear-handle device, it is possible to dispense with a footrest surface in the rear handle, thereby allowing said rear handle to have a more compact design. The footrest plate according to the invention is particularly advantageous for top-handle devices since there is no need to hold the top of the device, which otherwise would be critical for safety reasons. Moreover, it is also not necessary to provide a special footrest surface on the top of the device. Furthermore, thanks to the footrest plate according to the invention, no dirt from the shoe of the user can get near the fuel filling neck.

In order to allow simple handling, the footrest plate according to the invention should be freely accessible from the top. With such a configuration of the power tool, the user can simply step on the footrest plate from above in order to secure it without any other measures. This is not possible when the tool is held with the foot on the rear handle which, as a rule, has a closed design, irrespective of whether it is a rear-handle device or a top-handle device.

According to a preferred embodiment of the invention, the footrest plate as well as the first handle are formed on a part that is permanently joined to the housing of the power tool. Such a construction ensures the requisite force transmission from the housing to the footrest plate when the power tool is being started, and the assembly of the power tool is facilitated.

Preferably, said part is made primarily of plastic. In this case, the handle and the footrest plate can be manufactured cost-efficiently by means of injection molding without any additional work steps.

An especially suitable part for the first handle and the footrest plate is a bar that is at least joined to the lower section of the housing, preferably by means of screws.

The advantages of the inventive arrangement of the footrest plate in the center lower section of the power tool come to the fore particularly well in a power tool having a recoil starter whose starter grip is arranged between the first handle and the second handle relative to the lengthwise direction of the power tool. When the starter grip, which is connected to a pulling rope, is pulled upwards, owing to the center holding point, only a small tilting torque is generated, which can be easily compensated for by the pressure exerted by the user's foot.

As mentioned above, the invention can be used for top-handle devices in which the second handle is situated on top of the housing of the power tool as well as for rear-handle devices in which the second handle is arranged on the rear end of the power tool.

According to an advantageous refinement of the invention, a pair of rollers is arranged in the lower section of the power tool. The pair of rollers allows the user to easily move the power tool on the ground or on a surface that is to be processed.

Preferably, the pair of rollers is installed on the part onto which the footrest plate and the first handle have also been shaped. In this manner, the part, especially a bar, can be mounted on the housing of the power tool together with the footrest plate and the first handle, along with the pair of rollers, in the form of a preassembled unit.

### BRIEF DESCRIPTION OF THE DRAWINGS

Additional features and advantages of the invention ensue from the description below as well as from the accompanying drawings, to which reference is hereby made. The drawings show the following:

FIG. 1: a perspective view of a power tool according to the invention;

FIG. 2: a bottom view of the power tool of FIG. 1; and

FIG. 3: a perspective view of a handle of a power tool according to the invention, in another design variant.

### DETAILED DESCRIPTION

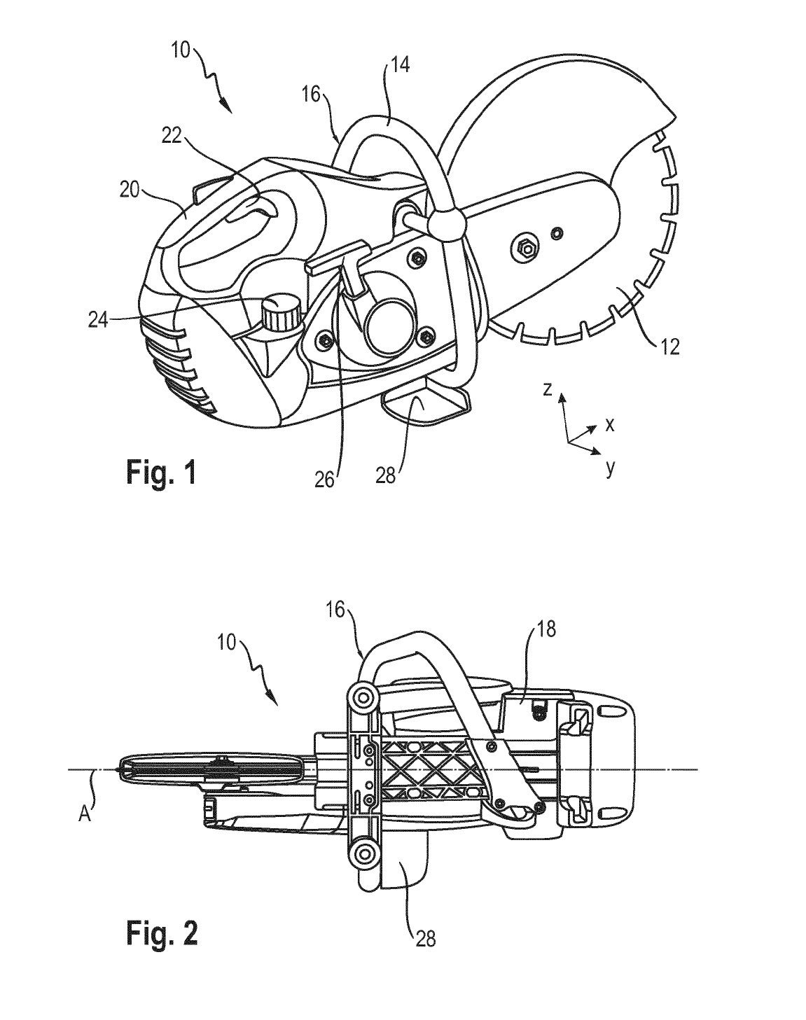

FIGS. 1 and 2 show a disc grinder as an example of a handheld, gasoline-powered power tool 10 with an internal combustion engine. According to the coordinate system indicated in FIG. 1, the normal orientation of such a power tool 10 is specified as follows: the z-direction faces “upwards”, the x-direction faces “forward” and the y-direction faces to one side. The x-direction also corresponds to the longitudinal axis A of the power tool 10 (see FIG. 2).

The power tool 10 has a tool 12 (here a grinding disc) in its front section. At the rear of the power tool 10, in a center section, there is a first handle 14 that is accessible from the top and that runs crosswise to the longitudinal axis A. The first handle 14 is part of a bar 16 that is permanently joined to the housing 18. The internal combustion engine of the power tool 10, among other things, is accommodated in the housing 18, which can be configured to consist of multiple parts.

The power tool 10 shown in FIGS. 1 and 2 is a so-called top-handle device. This means that a second handle 20, which only protrudes slightly or not at all beyond the rear end of the power tool 10, is situated on top of the housing 18 of the power tool 10 (above the engine). As is common practice for such power tools, the second handle 20 has a gas trigger 22 and, in contrast to the first handle 14, it runs parallel to the longitudinal axis A. Near the second handle 20, there is a tank opening 24 with a cap for fueling.

In the case of a so-called rear-handle device, the second handle 20 would not be arranged on the housing 18, but rather at the rear end of the power tool 10. Since the second handle 20, irrespective of a top-handle or rear-handle arrangement, is always located in the rear section of the power tool 10, and thus behind the first handle 14, one can generally speak of a front handle 14 and a rear handle 20.

There is a starter grip 26 that is located on one side relative to the lengthwise direction of the power tool 10 between the two handles 14 and 20, and that is part of a recoil starter. The starter grip 26 is connected to a pulling rope (not visible here) in a generally known manner. In order to start the internal combustion engine, the pulling rope has to be pulled by means of the starter grip 26 in an upwards motion out of the housing 18.

The power tool 10 also has a foot rest plate 28 that is freely accessible from the top and that is situated in the center lower section of the power tool 10. To put it in more precise terms, in the embodiment shown in FIGS. 1 and 2, the foot rest plate 28 is installed at a lower end of the bar 16 on which the front handle 14 is likewise formed.

The bar 16 as well as the foot rest plate 28 are essentially made of plastic and can be produced as a single part by means of injection molding.

The bar 16, together with the foot rest plate 28, is permanently joined to at least the lower section of the housing 18, for instance, by means of screws. In the case of a separate foot rest plate 28, however, it can also be suitably attached to the bar 16 or else directly to the housing 18.

In any case, the foot rest plate 28 is arranged and oriented in such a way that, during the starting procedure, the user can place a foot on the foot rest plate 28 and thus securely hold the power tool 10 on the ground without its tipping over in any direction. Moreover, the material and the dimensions of the foot rest plate 28 are configured such that the vertical forces that occur during the starting procedure can be absorbed by the housing 18. Furthermore, the foot rest plate 28 is also joined to the bar 16 so rigidly that it can compensate for the torque generated at the holding point during the starting procedure.

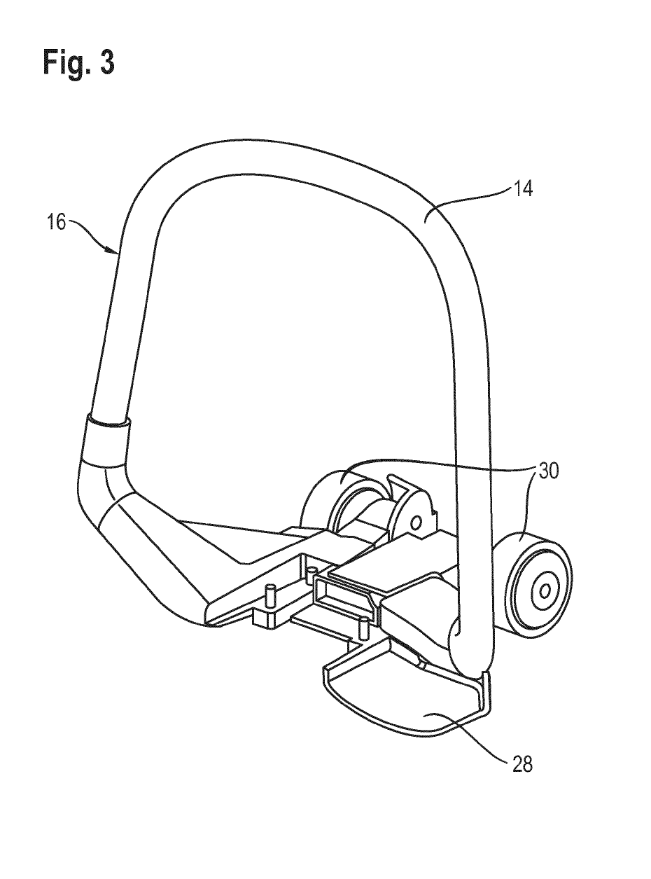

FIG. 3 shows a special variant of the bar 16. Aside from the integrated foot rest plate 28, the lower section of the bar 16 also has a fastening means for a pair of rollers 30. The pair of rollers 30 allows the user to tilt the power tool 10—which is resting on the ground or on the surface to be processed—forward and to quite effortlessly move it during work. The pair of rollers 30 is arranged in such a way that it does not hinder the function of the foot rest plate 28.

1-20. (canceled)

21. A handheld, gasoline-powered power tool comprising:
a tool in a front section of the power tool;
a first handle in a center upper section of the power tool;
a second handle in a rear section of the power tool; and
a footrest plate located in a center lower section of the power tool.

22. The power tool as recited in claim 21 wherein the footrest plate is freely accessible from a top.

23. The power tool as recited in claim 21 wherein the footrest plate as well as the first handle are formed on a part permanently joined to a housing of the power tool.

24. The power tool as recited in claim 23 wherein the part is made primarily of plastic.

25. The power tool as recited in claim 23 wherein the part is a bar at least joined to a lower section of the housing.

26. The power tool as recited in claim 25 wherein the bar is joined via screws to the lower section of the housing.

27. The power tool as recited in claim 21 further comprising a recoil starter with a starter grip arranged between the first handle and the second handle relative to a lengthwise direction of the power tool.

28. The power tool as recited in claim 21 wherein the second handle is situated on a top of a housing of the power tool.

29. The power tool as recited in claim 21 wherein the second handle is arranged at a rear end of the power tool.

30. The power tool as recited in claim 21 further comprising a pair of rollers is arranged in a lower section of the power tool.

31. The power tool as recited in claim 23 further comprising a pair of rollers is arranged in a lower section of the power tool, the pair of rollers being installed on the part.
